(19) United States
(12) Patent Application Publication
(10) Pub. No.: US 2013/0159136 A1
(43) Pub. Date: Jun. 20, 2013

(54) METHOD OF TRADING-IN APPLICATION, AND MARKET SERVER IMPLEMENTING THE SAME

(71) Applicants: Chul-Hyun PARK, Yongin-si (KR); Ho-Kun MOON, Seoul (KR); Ki-Chun SHIN, Anyang-si (KR)

(72) Inventors: Chul-Hyun PARK, Yongin-si (KR); Ho-Kun MOON, Seoul (KR); Ki-Chun SHIN, Anyang-si (KR)

(73) Assignee: KT CORPORATION, Seongnam-City (KR)

(21) Appl. No.: 13/614,891

(22) Filed: Sep. 13, 2012

(30) Foreign Application Priority Data
Dec. 16, 2011 (KR) 10-2011-0136782

(51) Int. Cl. G06Q 30/00

(52) U.S. Cl. 705/26.8

(57) ABSTRACT

A method of trade-in-selling an application to a user equipment by a market server, includes: searching trade-in target applications corresponding to trade-in items from applications sold to the user equipment; transferring a subscription message including a list of the trade-in target applications and a trade-in sale condition to the user equipment; receiving an acceptance message including return application information to be returned under the trade-in sale condition from the user equipment; deleting the return application from the user equipment and transferring a new application associated with the trade-in sale condition to the user equipment; and processing a settlement based on the trade-in sale condition when the user equipment completes installation of the new application.

### CROSS-REFERENCE TO RELATED APPLICATION

This application claims priority from Korean Patent Application No. 10-2011-0136782 filed in the Korean Intellectual Property Office on Dec. 16, 2011, the entire content of which is incorporated herein by reference in its entirety.

### BACKGROUND

(a) Field

Methods and apparatuses consistent with exemplary embodiments relate to a method of trading-in application, and a market server implementing the same.

(b) Description of the Related Art

In recent years, based on the increasing supply and demand for smart phones, the development of various applications executed in smart phones has been actively performed. A developer registers developed applications in an application market which is a sales market for applications. A smart phone user accesses the application market to purchase various applications. As illustrated above, the application market sells various contents with an application, manages the application, and distributes a profit to the developer.

If the application market allots a predetermined price to a paid application, a user purchases and then downloads the application. In this case, although the application is similar to or updated from a previously purchased application from the application market, the user should pay a price uniformly allotted from the application market and then obtain the application.

The above information disclosed in this Background section is only for enhancement of understanding of the background of the inventive concept and therefore it may contain information that does not form the prior art that is already known to a person of ordinary skill in the art.

### SUMMARY

Exemplary embodiments provide a method of trading-in applications, and a market server implementing the same having advantages of collecting an application installed in a user equipment and selling a new application by trade-in services.

An exemplary embodiment provides a method of trading-in applications, comprising: transferring, by a server, a first message comprising a list of one or more trade-in target applications and at least one trade-in sale condition; receiving a second message comprising return application information of a return application to be returned according to the at least one trade-in sale condition from a user equipment; and processing a settlement based at least on the at least one trade-in sale condition when the user equipment completes installation of a new application.

The method further comprising: searching for the one or more trade-in target applications corresponding to one or more trade-in items from among applications sold to the user equipment; and deleting the return application installed in the user equipment and transferring the new application associated with the at least one trade-in sale condition to the user equipment. The first message may be transferred to the user.

The at least one trade-in sale condition may comprise new application information related to the new application, the new application to be purchased under a condition of returning the one or more trade-in target applications.

The at least one trade-in sale condition may further comprise a sale price of the new application.

Transferring the first message may comprise transferring the subscription message when receiving a request for the list of the one or more trade-in target applications from the user equipment.

The second message may comprise the return application information and new application information of the new application, the new application being selected based on the at least one trade-in sale condition.

Transferring the new application comprises: requesting deletion of the return application from the user equipment; receiving deletion information of the return application from the user equipment; and transmitting the new application to the user equipment.

Another exemplary embodiment provides a method of trading-in applications, comprising: receiving, at a user equipment, a first message comprising a list of one or more trade-in target applications from among installed applications and receiving at least one trade-in sale condition; transferring a second message comprising return application information of a return application selected from the list; and receiving a new application selected based on the at least one trade-in sale condition.

The method may further comprise: receiving a signal requesting deletion of the return application, from a server; and deleting the return application and transferring deletion information to the server. The first message may be received from a server.

The second message may further comprise settlement information.

The method may further include receiving a settlement completion message from the server after completion of receiving the new application.

The method may further include monitoring whether the deletion of the return application is executed.

Yet another exemplary embodiment provides a server for trading-in applications, including: a trade-in target manager configured to select at least one trade-in item from a plurality of sale applications and manage the at least one trade-in item and at least one trade-in sale condition; a trade-in subscription unit configured to transfer a first message comprising a list of the one or more trade-in target applications and a corresponding one of the at least one trade-in sale condition to the user equipment; a trade-in sale manager configured to request deletion of a return application from the user equipment when receiving a second message including return application information of the return application, and configured to transfer a new application associated with the corresponding one of the at least one trade-in sale condition; and a settling unit configured to process a settlement based on the corresponding one of the at least one trade-in sale condition when the user equipment completes installation of the new application.

The trade-in subscription unit may be configured to search the one or more trade-in target applications corresponding to the at least one trade-in items from applications sold to the user equipment.

The trade-in target manager may manage the corresponding one of the at least one trade-in sale condition, the corresponding one of the at least one trade-in sale condition including new application information of the new application, the new application information provided under a condition of returning the return application and a sale price of the new application under a trade-in sale condition.

The trade-in subscription unit may transfer the first message when a request for the list of the trade-in target applications is received.

The trade-in sale manager may request deletion of the return application from the user equipment, and transfer the new application to the user equipment when deletion information of the return application is received from the user equipment.

According to exemplary embodiments, an application being a formless digital production may be traded-in. Accordingly, a market server may accelerate an applications sale with trade-in applications. Further, a user may purchase a new application at a discounted price with trade-in applications.

### BRIEF DESCRIPTION OF THE DRAWINGS

FIG. 1 is a schematic diagram illustrating a market system according to an exemplary embodiment.

FIG. 2 is a flowchart illustrating a method of trading-in an application according to an exemplary embodiment.

FIG. 3 is a block diagram illustrating a market server according to an exemplary embodiment.

FIG. 4 is a block diagram illustrating a user equipment (UE) according to an exemplary embodiment.

### DETAILED DESCRIPTION OF EXEMPLARY EMBODIMENTS

In the following detailed description, only certain exemplary embodiments have been shown and described, simply by way of illustration. As those skilled in the art would realize, the described exemplary embodiments may be modified in various different ways, all without departing from the spirit or scope of the inventive concept. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

Hereinafter, a method of trading-in an application, and a market server implementing the same will be described in detail with reference to the accompanying drawings.

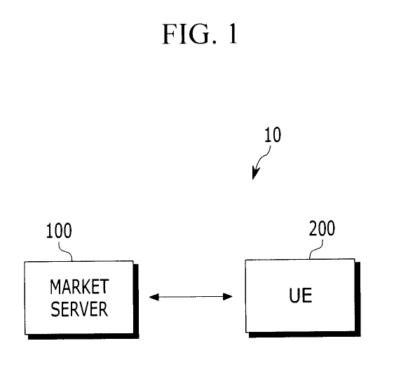

FIG. 1 is a schematic diagram illustrating a market system according to an exemplary embodiment.

Referring to FIG. 1, a market system 10 includes a market server 100 and a user equipment, UE 200. The market server 100 sells applications, and the UE 200 purchases the applications from the market server 100 to install them. In this case, the market server 100 manages user information and information about the applications sold to the UE 200.

The market server 100 provides a trade-in service for applications. For the trade-in, the market server 100 collects an installed application from the UE 200, and sells a new application to the UE 200 at a reduced price. That is, in a similar way that a seller of a product collects an old product and sells a new product at a discounted price in exchange for the old product, the market server 100 collects an old application installed in the UE 200 and transfers a new application in exchange for the old installed application. The UE 200 returns the old installed application and buys a new application instead. In this case, because the application is a type of digital product, the market server 100 and the UE 200 may collect and return the old application by way of deleting the old application. Further, the market server 100 may sell the new application and the UE 200 may purchase the new application by either newly installing the application or updating an installed application, respectively.

The UE 200 accesses the market server 100 to download the application. Moreover, the UE 200 manages the installed application through an application manager communicating with the market server 100, and deletes the installed application. In addition, the UE 200 monitors whether an application without use authority is executed.

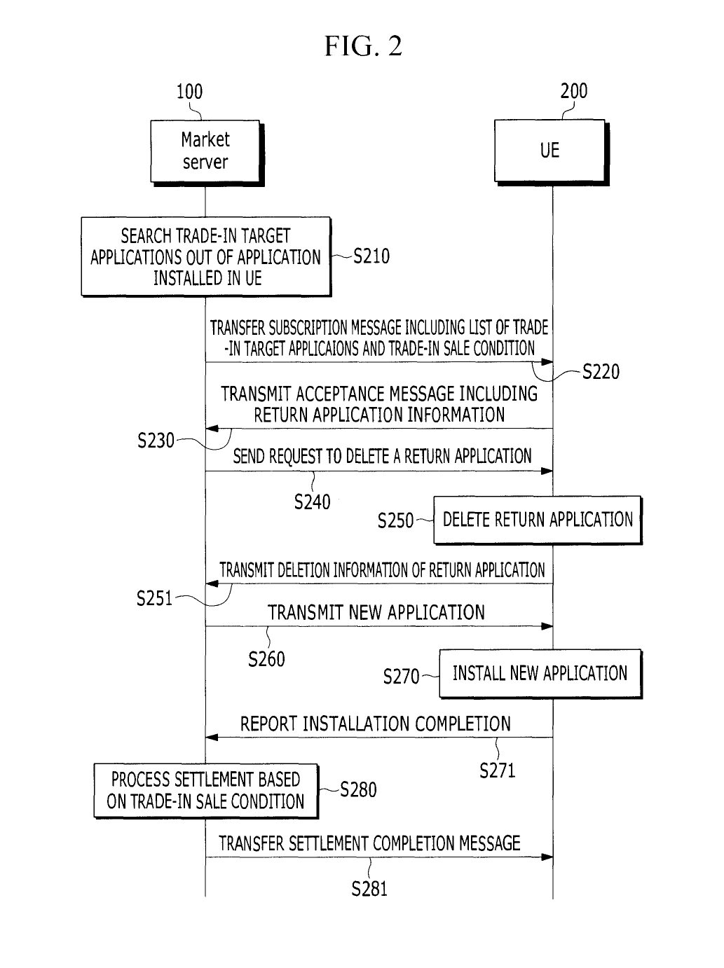

FIG. 2 is a flowchart illustrating a method of trading-in an application according to an exemplary embodiment.

Referring to FIG. 2, a market server 100 searches trade-in target applications out of applications installed in the UE 200, by comparing the applications installed in the UE 200 and trade-in items registered in the market server 100, respectively (S210). To do this, the market server 100 manages user information and information about the applications sold to the UE 200. Further, the market server 100 selects trade-in items from a plurality of sale applications, and sets a trade-in sale condition for applications corresponding to the trade-in items, respectively. In this case, the trade-in sale condition may include a list of new applications to be sold with a trade-in sale and sale prices of the new applications. Meanwhile, the trade-in sale condition may be an amount of money discounted when purchasing the new applications without specifying the new applications. The market server 100 may search a purchase history achieved by the UE 200 so as to send a trade-in sale guide message. Also, upon receiving a request for a list of applications which can be purchased with a trade-in sale, the market server 100 may search a purchase history.

The market server 100 transfers a subscription message including a list of trade-in target applications and a trade-in sale condition to the UE 200 (S220). That is, the market server 100 provides new application information to be sold under a condition of returning an installed trade-in target application, and inquires whether the UE 200 accepts the trade-in sale condition.

When accepting the trade-in sale condition, the UE 200 transmits an acceptance message including return application information for returning an application to the market server 100 (S230). The acceptance message may further contain new application information selected based on the trade-in sale condition. The acceptance message may further contain settlement information.

The market server 100 sends a request to delete a return application, to the UE 200 (S240).

The UE 200 deletes the return application (S250).

Further, the UE 200 transmits deletion information of the return application (S251).

After the return application is deleted, the market server 100 transmits a new application to the UE 200 (S260). That is, upon receiving a deletion report of the return application, the market server 100 may set a settlement procedure in a temporary trade-in sale determination state. Further, the market server 100 transmits a new application requested from the UE 200.

The UE 200 installs the new application (S270).

In addition, the UE 200 reports installation completion (S271).

The market server 100 processes a settlement based on the trade-in sale condition (S280). Upon receiving an installation completion report, the market server 100 sets a settlement procedure in a trade-in sale determination state to complete the settlement.

The market server 100 transfers a settlement completion message to the UE 20 (S281).

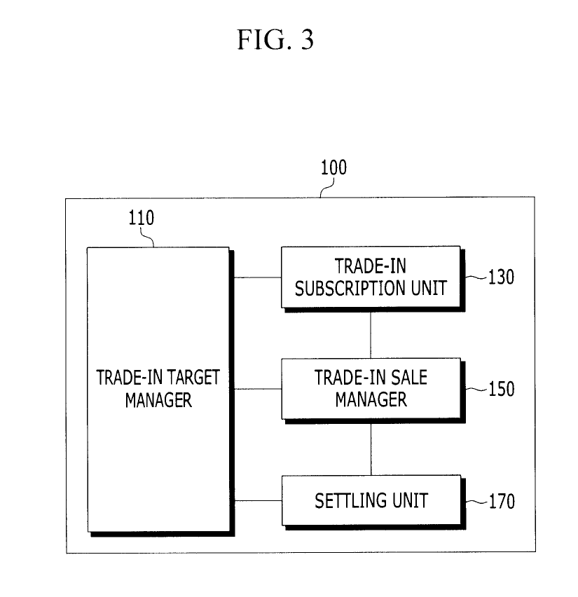

FIG. 3 is a block diagram illustrating a market server according to an exemplary embodiment.

Referring to FIG. 3, a market server 100 includes a trade-in target manager 110, a trade-in subscription unit 130, a trade-in sale manager 150, and a settling unit 170. The market server 100 may be equipped with a central processing unit (CPU) and a memory (not shown). The trade-in target manager 110, trade-in subscription unit 130, trade-in sale manager 150, and settling unit 170 may be implemented in a hardware component, software module, or via a combination of hardware and software.

The trade-in target manager 110 selects trade-in items from a plurality of sale applications, and manages the trade-in items and a trade-in sale condition. The trade-in target manager 110 manages the trade-in sale condition for applications corresponding to the trade-in items, respectively. In this case, the trade-in sale condition may include a list of new applications to be sold as part of a trade-in sale and sale prices of the new applications. Meanwhile, the trade-in sale condition may be an amount of money discounted when selling the new applications without specifying the new applications.

The trade-in subscription unit 130 transfers a subscription message of trade-in sale to the UE 200. The subscription message may include a list of trade-in target applications and a corresponding trade-in sale condition. To do this, the trade-in subscription unit 130 searches the trade-in target manager 110 to discover trade-in target applications corresponding to the trade-in items, from applications installed in the UE 200, respectively. The trade-in subscription unit 130 may periodically or aperiodically search whether the UE 200 has the trade-in target applications or not, and transmit a subscription message to the UE 200. Also, the trade-in subscription unit 130 may transmit a subscription message in response to a request of the UE 200.

When receiving an acceptance message related to the trade-in sale from the UE 200, the trade-in sale manager 150 manages the trade-in sale according to a procedure. The trade-in sale manager 150 causes the UE 200 to delete a return application in order to continue processing the trade-in sale. Further, if the return application is deleted, the trade-in sale manager 150 transfers a new application associated with the trade-in sale condition to the UE 200.

If the UE 200 completes installation of the new application, the settling unit 170 processes a settlement based on the trade-in sale condition. The settling unit 170 transfers a settlement completion message to the UE 200.

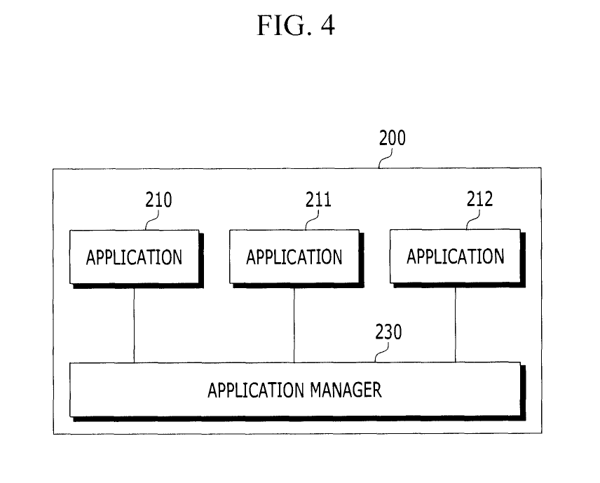

FIG. 4 is a block diagram illustrating a UE according to an exemplary embodiment.

Referring to FIG. 4, the UE 200 includes a plurality of applications 210, 211, and 212, and an application manager 230. The UE 200 may be equipped with a central processing unit (CPU) and a memory (not shown). The application manager 230 may be implemented using a hardware component, software module, or via a combination of hardware and software.

The plurality of applications 210, 211, and 212 are an application program with contents, which are executed using various software and hardware resources. The plurality of applications 210, 211, and 212 are downloaded and installed from the market server 100.

The application manager 230 manages the plurality of applications 210, 211, and 212, and communicates with the market server 100. When receiving a request to delete an application, from the market server 100, the application manager 230 deletes a corresponding application and reports the deletion of the application to the market server 100.

The application manager 230 monitors whether the plurality of applications 210, 211, and 212 are properly purchased and installed. The application manager 230 compares the applications 210, 211, and 212 installed in the UE 200 with sale applications of the UE 200 stored in the market server 100.

The application manager 230 monitors whether an application returned as a trade-in application is executed. The application manager 230 may manage a return application list therein. Also, the application manager 230 may monitor execution of a return application based on a trade-in history stored in the market server 100. If an application without the appropriate authority or license to use the application, is detected, the application manager 230 may generate an alarm message to delete the application or block execution of the application. Meanwhile, the application manager 230 may provide a purchase screen related to the market server 100 such that the authority to use the application may be purchased.

As illustrated above, the market server 100 may trade-in an application which is a formless digital product. Accordingly, the market server 100 may accelerate sale of an application with trade-in applications, and the user may purchase a new application at a discounted price with the trade-in applications.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the appended claims.

What is claimed is:

1. A method of trading-in applications, comprising:
transferring, by a server, a first message comprising a list of one or more trade-in target applications and at least one trade-in sale condition;
receiving a second message comprising return application information of a return application to be returned according to the at least one trade-in sale condition, from a user equipment;
and
processing a settlement based at least on the at least one trade-in sale condition when the user equipment completes installation of a new application.

2. The method of claim 1, further comprising:
searching for the one or more trade-in target applications corresponding to one or more trade-in items from among applications sold to the user equipment; and
deleting the return application installed in the user equipment and transferring the new application associated with the at least one trade-in sale condition to the user equipment.

3. The method of claim 1, wherein the first message is transferred to the user equipment.

4. The method of claim 1, wherein:
the at least one trade-in sale condition comprises new application information related to the new application, the new application to be purchased under a condition of returning at least one of the one or more trade-in target applications.

5. The method of claim 4, wherein:
the at least one trade-in sale condition further comprises a sale price of the new application.

6. The method of claim 1, wherein:
transferring the first message comprises:
transferring the first message when receiving a request for the list of the one or more trade-in target applications from the user equipment.

7. The method of claim 1, wherein:
the second message comprises the return application information and new application information of the new application, the new application being selected based on the at least one trade-in sale condition.

8. The method of claim 2, wherein:
transferring the new application comprises:
requesting deletion of the return application from the user equipment;
receiving deletion information of the return application from the user equipment; and
transmitting the new application to the user equipment.

9. A method of trading-in applications, comprising:
receiving, at a user equipment, a first message comprising a list of one or more trade-in target applications from among installed applications and receiving at least one trade-in sale condition;
transferring a second message comprising return application information of a return application selected from the list; and
receiving a new application selected based on at least the at least one trade-in sale condition.

10. The method of claim 9, further comprising:
receiving a signal requesting deletion of the return application, from a server; and
deleting the return application and transferring deletion information to the server.

11. The method of claim 9, wherein the first message is received from a server.

12. The method of claim 9, wherein:
the second message further comprises settlement information.

13. The method of claim 9, further comprising:
receiving a settlement completion message from the server after completion of receiving the new application.

14. The method of claim 10, further comprising:
monitoring whether the deletion of the return application is executed.

15. A server for trading-in applications, comprising:
a trade-in target manager configured to select at least one trade-in item from a plurality of sale applications and manage the at least one trade-in item and at least one trade-in sale condition;
a trade-in subscription unit configured to transfer a first message including a list of one or more trade-in target applications and a corresponding one of the at least one trade-in sale condition to the user equipment;
a trade-in sale manager configured to request deletion of a return application from the user equipment when receiving a second message including return application information of the return application, and configured to transfer a new application associated with the corresponding one of the at least one trade-in sale condition; and
a settling unit configured to process a settlement based on the corresponding one of the at least one trade-in sale condition when the user equipment completes installation of the new application.

16. The server of claim 15, wherein the trade-in subscription unit is configured to search the one or more trade-in target applications corresponding to the at least one trade-in items from applications sold to the user equipment.

17. The server of claim 15, wherein:
the trade-in target manager manages the corresponding one of the at least one trade-in sale condition, the corresponding one of the at least one trade-in sale condition including new application information of the new application, the new application information provided under a condition of returning the return application and a sale price of the new application.

18. The server of claim 15, wherein:
the trade-in subscription unit transfers the first message when a request for the list of the trade-in target applications is received.

19. The server of claim 18, wherein:
the trade-in sale manager requests deletion of the return application from the user equipment, and transfers the new application to the user equipment when deletion information of the return application is received from the user equipment.
